(19) United States
(12) Patent Application Publication
(10) Pub. No.: US 2004/0052494 A1
(43) Pub. Date: Mar. 18, 2004

(54) Optical fiber array and optical fiber collimator array and optical module using the same

(76) Inventor: Fumitoshi Kobayashi, Osaka (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/617,051

(22) Filed: Jul. 11, 2003

(30) Foreign Application Priority Data
Jul. 11, 2002 (JP) P2002-202190

(51) Int. Cl. G02B 6/00

(52) U.S. Cl. 385/137

(57) ABSTRACT

According to the invention, there is provided an optical fiber array including a plurality of through-hole array boards each made of a plate-like board having a plurality of through-holes provided at regular intervals in a direction substantially perpendicular to a board surface of the plate-like board, and a plurality of optical fibers having end portions inserted and held in the plurality of through-hole array boards. In order to solve the problem, the plurality of through-hole array boards are laminated so as to be in contact with one another, and the plurality of through-hole array boards are positioned in such a manner that center axes of corresponding through-holes formed in the boards are relatively displaced from a coaxial position so that each optical fiber inserted in the corresponding through-holes comes into contact with inner walls of the corresponding through-holes at a plurality of points.

The present application is based on Japanese Patent Application No. 2002-202190, the entire contents of which are incorporated herein by reference.

### BACKGROUND OF THE INVENTION

1. Field of the Invention

The present invention relates to an optical fiber array mainly used in the field of optical communication.

2. Related Art

In optical communication, a large number of optical signals need to be processed in parallel. In this case, an optical fiber array is used so that a large number of optical devices are connected to one another by optical fibers. When the number of optical fibers increases, a process of aligning and coupling the optical fibers with other optical devices individually becomes very complex. Therefore, the optical fiber array is very useful in fixing respective front ends of the optical fibers with high accuracy in relative positions thereof to facilitate coupling of the optical fibers to other optical devices.

In most cases, a one-dimensional arrangement optical fiber array is formed in such a manner that optical fibers 20 are arranged in grooves (so-called V-grooves) 50 each shaped like a V figure in section and formed in a planar board 52 as shown in FIG. 9A. A keep plate 54 is stuck close onto a top surface of the board 52 having the V-grooves 50 to thereby fix the respective optical fibers 20. Incidentally, respective end surfaces 20a of the optical fibers 20 are normally polished so as to be on the same plane with a surface 52a of the board 52.

A two-dimensional arrangement optical fiber array having optical fibers arranged vertically and horizontally can be formed in such a manner that optical fibers 20 are arranged in V-grooves 50 formed in boards 52 in the condition that the boards 52 having the V-grooves 50 are laminated as shown in FIG. 9B. Incidentally, a keep plate 54 for each lower board can be dispensed with if optical fibers are fixed by a bottom surface of a board just above the lower board.

There is also known an optical fiber array formed in such a manner that through-holes 62 each shaped like a circle in section are two-dimensionally arranged in a planer board 58 to thereby position front ends of optical fibers 20 as shown in FIG. 10. The through-holes are formed by a processing method such as laser processing, mechanical processing due to a drill or the like, etching, etc.

In the example in which the V-grooves are used for production of the related-art two-dimensional optical fiber array, it is however difficult to keep the optical fiber interval high in the direction of lamination of the V-grooves due to variation in the depth of the V-groove and the diameter of the optical fiber though it is possible to keep the accuracy of the optical fiber interval high in the direction of arrangement of the V-grooves. Furthermore, if relative positional displacement occurs at the time of lamination, a pin, a jig, or the like needs to be used for adjusting the displacement or a special process needs to be applied to each V-groove board as described in JP-A-10-20141.

In the method using the two-dimensional arrangement circular through-hole array, the hole diameter of each of the through-holes 62 needs to be set to be slightly larger than the diameter of each of the optical fibers 20 as shown in FIG. 11 in order to secure clearance sufficient to make the optical fiber pass through the through hole 62. For this reason, even in the case where the accuracy of the hole diameter of each of the through-holes 62 and the accuracy of the interval are improved, there still arises a problem that the positional accuracy of each optical fiber is lowered by the clearance as shown in FIG. 11.

As a measure against the problem, a method of providing rough portions both in an end surface of each optical fiber and in a positioning board to thereby fit the end surface of the optical fiber and the positioning board to each other has been proposed in JP-A-2-123301. In the proposed method, it is however necessary to process the optical fiber and the positioning board.

### SUMMARY OF THE INVENTION

The invention is based on attention to the problems in the related art. An object of the invention is to arrange two-dimensionally a large number of optical fibers with high positional accuracy so that positioning without actual propagation of light in optical devices to be coupled (so-called passive alignment) can be performed. Accordingly, a small-size, high-density and low-cost optical fiber array can be provided, so that an optical system using the optical fiber array can be constructed easily.

According to the invention, there is provided an optical fiber array including a plurality of through-hole array boards each made of a plate-like board having a plurality of through-holes provided at regular intervals in a direction substantially perpendicular to a board surface of the plate-like board, and a plurality of optical fibers having end portions inserted and held in the plurality of through-hole array boards. In order to achieve the object, the plurality of through-hole array boards are laminated so as to be in contact with one another, and the plurality of through-hole array boards are positioned in such a manner that center axes of corresponding through-holes formed in the boards are relatively displaced from a coaxial position so that each optical fiber inserted in the corresponding through-holes comes into contact with inner walls of the corresponding through-holes at a plurality of points.

Preferably, each of the through-holes is shaped like a circle, an ellipse or an oblong in section. Preferably, each of the through-holes is shaped like a polygon or a rounded-corner polygon in section.

The optical fibers are perpendicular to surfaces of the plurality of through-hole array boards or inclined at a predetermined angle in a predetermined direction with respect to the surfaces of the plurality of through-hole array boards.

When an optical fiber array according to the invention and a planar micro lens array having a lens interval corresponding to the optical fiber interval of the optical fiber array are combined with each other, an optical fiber collimator array can be provided. Further, when the optical fiber collimator array and an optically functional device array having a device interval corresponding to the collimator interval of the optical fiber collimator array are combined with each other, an optical module can be provided.

When the optical fiber array and an optically functional device array having a device interval corresponding to the optical fiber interval of the optical fiber array are combined with each other, an optical module can be also provided.

### BRIEF DESCRIPTION OF THE DRAWINGS

FIGS. 1A to 1C are typical views showing an example of a method for assembling an optical fiber array according to the invention;

FIG. 2 is a view showing an example of a state of fixation of optical fibers in the optical fiber array according to the invention;

FIG. 3 is a typical sectional view showing the configuration of the optical fiber array using three through-hole array boards;

FIG. 4 is a view showing an example in which optical fibers are fixed obliquely by through-hole array boards;

FIG. 5 is a view showing an example of a through-hole array board having through-holes each shaped like a rounded-corner triangle;

FIG. 6 is a view showing another example of the state of fixation of optical fibers in the optical fiber array according to the invention;

FIG. 7 is a view showing examples of combination of through-hole shapes for positioning each optical fiber at three points;

FIG. 8 is a view showing examples of combination of through-hole shapes for positioning each optical fiber at four points;

FIGS. 9A and 9B are perspective views showing a two-dimensional optical fiber array using related-art V-groove boards;

FIG. 10 is a perspective view showing a two-dimensional optical fiber array using a related-art through-hole array board; and

FIG. 11 is a view showing a problem in the related-art through-hole array board.

### DETAILED DESCRIPTION OF THE PREFERRED EMBODIMENTS

(Embodiment 1)

An optical module according to a first embodiment of the invention will be described below in detail.

The board used was a 0.3 mm-thick aluminosilicate glass board having surfaces ion-exchanged with Ag. A scaled-down image-forming optical system using a KrF excimer laser as a light source was used for forming a scaled-down image of a photo-mask pattern having a desired shape and size to thereby process through-holes in the board. The laser processing threshold of the glass board could be reduced by the ion exchange with Ag, so that a through-hole array could be produced easily. The through-hole array board produced thus had 3×3 through-holes (nine through-holes in total) arranged at intervals of 250 μm. The hole diameter of each through-hole was Φ135 μm.

Although this embodiment has been described on the case where collective laser processing is performed with use of a photo mask, the invention may be also applied to the case where through-holes are processed one by one by means of laser while the hole interval is controlled by a fine adjustment table or the like. Alternatively, the through-holes may be processed mechanically by a drill or the like.

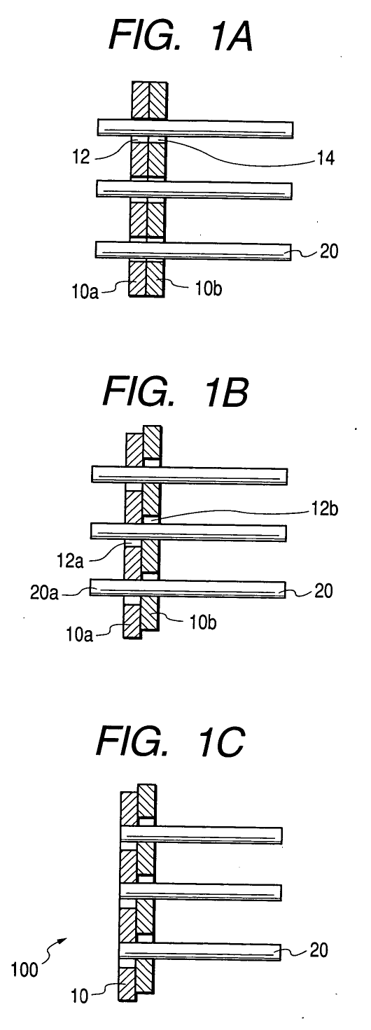

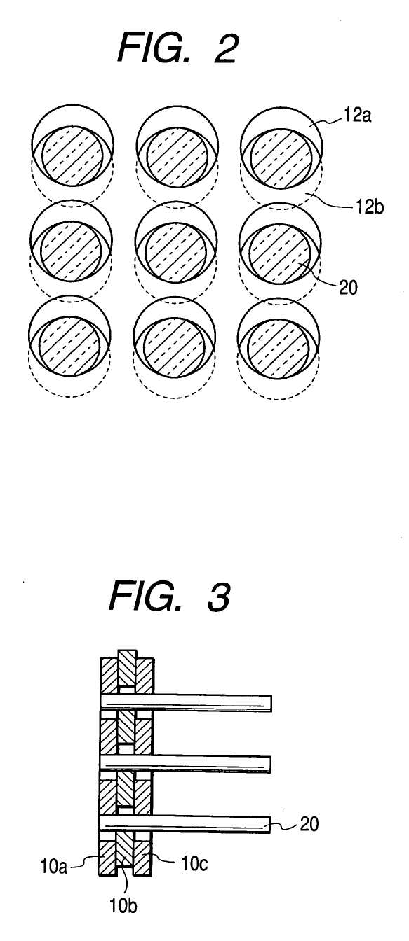

Next, a method of assembling the optical fiber array will be described with reference to FIGS. 1A through 1C. First, in the condition that a pair of through-hole array boards 10a and 10b produced in the aforementioned manner are stuck onto each other so that center axes of circular through-holes 12 become coaxial, optical fibers 20 are inserted in the through-holes 12 respectively (FIG. 1A). Then, an ultraviolet-curable adhesive agent is applied onto clearance portions 14 between the through-holes 12 and the optical fibers 20. Then, the ultraviolet-curable adhesive agent is cured by irradiation with ultraviolet rays in the condition that the pair of through-hole array boards 10a and 10b are relatively displaced from each other to thereby bring the optical fibers 20 into contact with the pair of boards 10a and 10b, that is, in the condition that the optical fibers 20 are clamped (FIG. 1B). FIG. 2 is a sectional view showing a state of contact between the inside of the through-holes and the optical fibers in this case (numerals like those parts in FIGS. 1A to 1C are denoted by the same reference numbers). Then, portions 20a of the optical fibers 20 protruded from the integrated through-hole array board 10 are cut off and polished to thereby accomplish the optical fiber array 100 (FIG. 1C).

Although this embodiment has been described on the case where a pair of through-hole array boards are piled on each other, the invention may be also applied to the case where two or more boards are piled on one another. FIG. 3 shows an example in which three through-hole array boards 10a, 10b and 10c are piled on one another to improve the state of supporting the optical fibers 20.

In the related-art method in which optical fibers were inserted and fixed in a single through-hole array board, it was necessary to increase the hole diameter of each through-hole by at least 1 μm in anticipation of clearance at the time of insertion of the optical fibers. In addition, because it was very difficult to accurately control the hole diameter of each through-hole, it was necessary to allow a margin in a direction of increase of the hole diameter of each through-hole. Consequently, a board having through-holes each having a hole diameter larger by about 3 μm than the optical fiber diameter was used in the related art.

In an optical fiber array assembled by using the related-art single through-hole array board, the positional accuracy of the optical fiber interval was about ±1.5 μm because of the necessity of keeping the margin of the hole diameter and the clearance. In the optical fiber array according to this embodiment, because the clearance between the optical fibers and the through-holes can be set to zero, the positional accuracy can be improved to about ±0.5 μm in a direction of clamping the optical fibers and to about ±1 μm in a direction perpendicular to the clamping direction.

In order to perform positioning of the optical fibers by using the related-art single through-hole array board, it was necessary to control the absolute value of the hole diameter of each through-hole and variation in the hole diameter. On the contrary, the method according to the invention does not largely depend on the absolute value of the hole diameter. Accordingly, processing can be performed if attention is paid only to variation in the hole diameter, so that the through-hole array board can be produced easily.

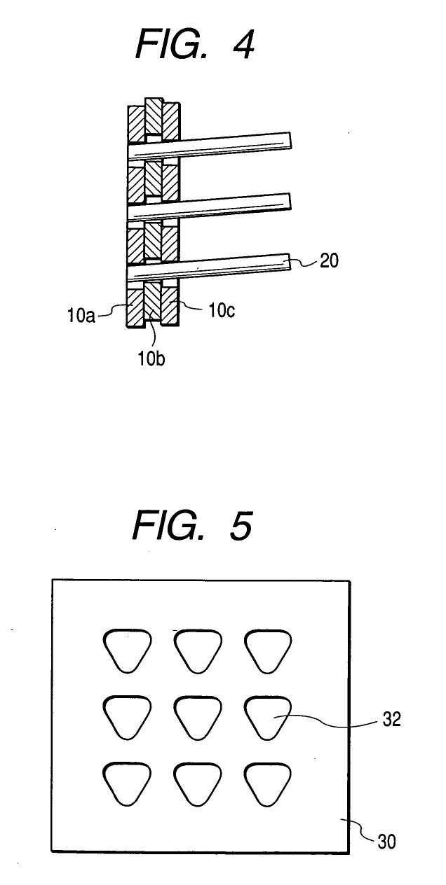

In addition, when the quantities of relative displacement of the through-hole array boards 10a, 10b and 10c are adjusted as shown in FIG. 4, the angle of each optical fiber 20 can be controlled optionally.

(Embodiment 2)

FIG. 5 shows a through-hole array board 30 according to this embodiment. In this embodiment, a through-hole array board 30 having through-holes 32 each shaped like a triangle (rounded-corner triangle) was used. Each of the through-holes 32 was shaped like a so-called rounded-corner triangle having corners processed into smooth curves. The through-hole array board 30 was produced while a mask having the same shape as that of the board shown in FIG. 5 was used in excimer laser processing. The through-holes 32 were processed as 3×3 through-holes (nine through-holes in total) arranged at intervals of 250 μm in the same manner as in Embodiment 1. The diameter of an inscribed circle of each through-hole was Φ135 μm.

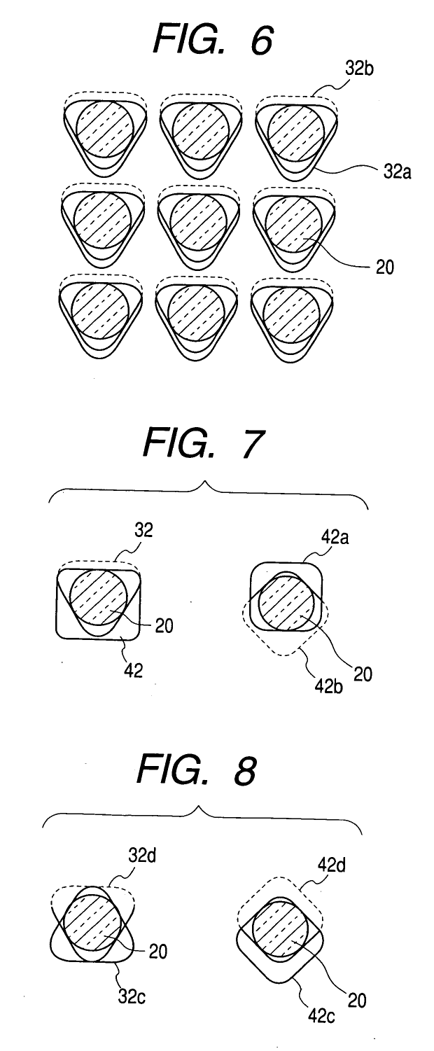

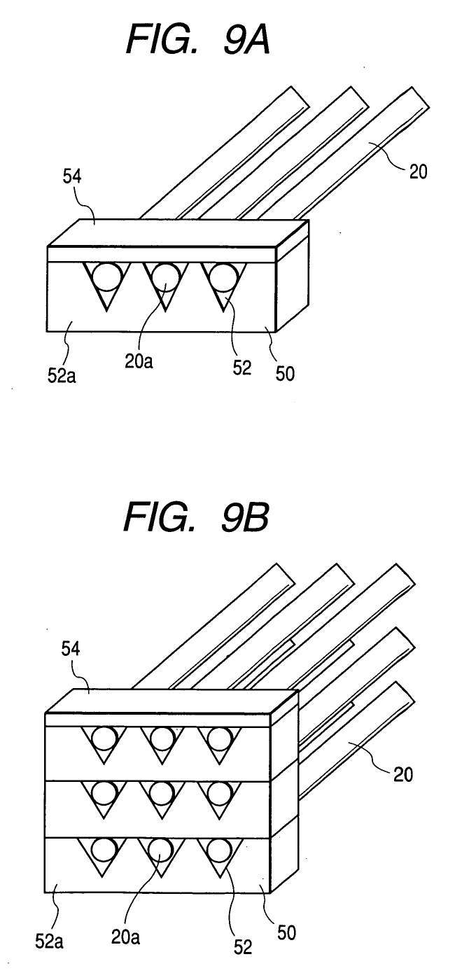

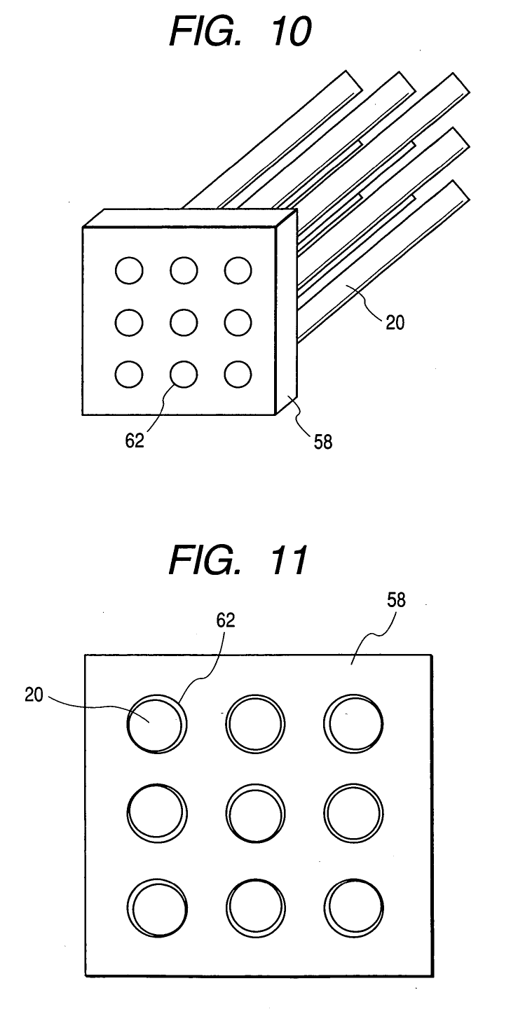

Through-hole array boards produced thus were used so that an optical fiber array was assembled in the same manner as in Embodiment 1. Because each optical fiber 20 was positioned at three points by two through-holes 32a and 32b as shown in FIG. 6, the positioning could be performed stably compared with the positioning at two points in Embodiment 1. The positioning accuracy was improved to about ±0.5 μm compared with about ±1.5 μm in the related-art method. In Embodiment 1 in which a plurality of circular through-holes were used, the positioning accuracy in the horizontal direction shown in FIG. 2 was not so good because of the positioning of each optical fiber at two points.

Although this embodiment has been described on the case where optical fibers are positioned by a plurality of boards having rounded-corner triangle-shaped through-hole arrays of the same shape respectively, the invention may be also applied to the case where positioning is performed at three points by a combination of triangular through-holes 32 and quadrangular through-holes 42 or by a combination of two kinds of quadrangular through-holes 42a and 42b as shown in FIG. 7.

Alternatively, through-holes 32c, 32d, 42c and 42d having various kinds of shapes as shown in FIG. 8 may be used for positioning each optical fiber at four points. Although the positioning at four points is often slightly interior in positioning accuracy to the positioning at three points, the accuracy of the optical fiber interval is improved compared with the use of circular through-holes in Embodiment 1.

Although this embodiment has been described on the case where each through-hole is shaped like a rounded-corner polygon, that is, a chamfered polygon in section in order to avoid concentration of stress onto corners of the polygon, the invention may be also applied to the case where each through-hole shaped like a polygon having corners is used according to the board material.

As described above, in accordance with the invention, a large number of optical fibers can be passively aligned and fixed collectively. Accordingly, an optical fiber array can be produced inexpensively in a short time.

In addition, angles of the large number of optical fibers can be adjusted simultaneously. Accordingly, various optical modules can be provided.

What is claimed is:

1. An optical fiber array comprising:
a plurality of through-hole array boards each made of a plate-like board having a plurality of through-holes provided at regular intervals in a direction substantially perpendicular to a board surface of said plate-like board, and a plurality of optical fibers having end portions inserted and held in said plurality of through-hole array boards, wherein:
said plurality of through-hole array boards are laminated so as to be in contact with one another; and
said plurality of through-hole array boards are positioned in such a manner that center axes of corresponding through-holes formed in said boards are relatively displaced from a coaxial position so that each optical fiber inserted in said corresponding through-holes comes into contact with inner walls of said corresponding through-holes at a plurality of points.

2. An optical fiber array according to claim 1, wherein each of said through-holes is shaped like a circle, an ellipse or an oblong in section.

3. An optical fiber array according to claim 1, wherein each of said through-holes is shaped like a polygon or a rounded-corner polygon in section.

4. An optical fiber array according to claim 1, wherein said optical fibers are perpendicular to surfaces of said plurality of through-hole array boards or inclined at a predetermined angle in a predetermined direction with respect to the surfaces of said plurality of through-hole array boards.

5. An optical fiber collimator array comprising a combination of an optical fiber array defined in claim 1 and a planar microlens array having a lens interval corresponding to an optical fiber interval of said optical fiber array.

6. An optical module comprising a combination of an optical fiber collimator array defined in claim 5 and an optically functional device array having a device interval corresponding to a collimator interval of said optical fiber collimator array.

7. An optical module comprising a combination of an optical fiber array defined in any one of claims 1 through 4 and an optically functional device array having a device interval corresponding to an optical fiber interval of said optical fiber array.
